(19) United States
(12) Patent Application Publication
(10) Pub. No.: US 2015/0311730 A1
(43) Pub. Date: Oct. 29, 2015

(54) Charging Device

(71) Applicant: HITACHI KOKI CO., LTD., Tokyo (JP)

(72) Inventors: Takao Aradachi, Hitachinaka, Ibaraki (JP); Kazuhiko Funabashi, Hitachinaka, Ibaraki (JP); Kenji Shimatsu, Iwaki, Fukushima (JP)

(21) Appl. No.: 14/649,389

(22) PCT Filed: Dec. 9, 2013
(86) PCT No.: PCT/JP2013/007232

§ 371 Date: Jun. 3, 2015

(30) Foreign Application Priority Data
Dec. 7, 2012 (JP) 2012-268862
Dec. 7, 2012 (JP) 2012-268863

(51) Int. Cl. H02J 7/00

(52) U.S. Cl. CPC H02J 7/0021; H02J 7/0026; H02J 7/0024; H02J 2007/0095

(57) ABSTRACT

In a charging device, a terminal is configured to connect a rechargeable battery. A first power feeding unit is configured to charge the rechargeable battery connected to the terminal. A controller is configured to control the first power feeding unit. A second power feeding unit is configured to feed electrical power to the controller and a monitoring unit. The monitoring unit includes a monitoring portion and a switching element. The monitoring portion is configured to monitor at least one of the rechargeable battery, the first power feeding unit, and the controller. The switching element is configured to interrupt the second power feeding unit to feed the electrical power to the monitoring portion.

### TECHNICAL FIELD

The present invention relates to a charging device that charges a rechargeable battery used as a power source of a cordless electric power tool. Further, the present invention relates to a charging device capable of selectively charging battery packs of different rated voltages.

### BACKGROUND ART

Various types of cordless electric power tools are used depending on the intended use. For examples, the power tools varies in sizes, shapes, and power levels. Further, rechargeable batteries of various rated output voltages and capacities are used in the power tools. For example, a lithium-ion battery pack whose rated voltage is 3.6V is used for light-work, and a lithium-ion battery pack whose rated voltage is 36V is used for hard-work.

A recharging device that is dedicated to a single type of the various battery pack is provided. Further, a multi-type charging device capable of charging a plurality of battery packs is provided for improving convenience of users. For example, Japanese Patent Application Publication No. 2009 178012 discloses a multi-type charging device that can charge the battery packs of different rated voltages. This multi-type charging device identifies the type and voltage of the battery in order to charge the battery pack appropriately. More specifically, the battery pack has an identification element such as a resistor, which varies according to the type of the rechargeable battery or a charge-discharge voltage. At the time of charging, the charging device identifies the identification element.

When a high-voltage battery pack or large-capacity battery back is charged, or when quick charging is carried out, output power of the charging device tends to become larger, thereby requiring not only monitoring temperatures of the battery pack but also monitoring temperatures of components inside the charging device. Therefore, the charging device determines the temperature of the battery pack, and the temperature inside the charging device. If the temperatures are greater than or equal to predetermined temperatures, the charging device reduces an output charging current, thereby reducing generation of heat.

### SUMMARY OF INVENTION

### Solution to Problem

Recently, the charging device is increasingly required to reduce power consumption for reasons such as environmental consciousness. In particular, power that is consumed by the charging device in a standby mode after the charging is completed does not contribute to supply of energy to the battery pack. Therefore, it is desirable that the value be as low as possible. However, the above conventional battery type determination method and temperature monitoring method do not pay little attention to a reduction in power consumption.

In view of the foregoing, the object of the present invention is to provide a charging device that can reduce power consumption while reliably carrying out identification of a plurality of battery-voltage types and monitoring of temperatures.

Further, a growing number of battery packs have adopted high-performance rechargeable batteries such as lithium-ion batteries in order to meet demand for higher output and larger capacity (longer work time). The high-performance rechargeable batteries require strict conditions for charging and discharging in order to sufficiently ensure life and performance thereof. Attention needs to be paid not only to a voltage during charging that is set based on the rated voltage and a voltage at which the charging is completed, but also to the state and voltage of the battery at the start of the charging. Unlike a charging device dedicated to a specific battery pack with preset charging conditions, the multi-type charging device needs to determine the state of a plurality of battery packs and carry out charging in accordance with the type of the battery packs.

In view of the foregoing, another object of the present invention is to provide a charging device that can selectively charge a plurality of battery packs of different rated voltages, appropriately determine the state of a battery at a time when charging of a battery pack is started and a voltage thereof, and carry out charging under suitable charging conditions.

The present invention features a charging device. The charging device includes a terminal, a first power feeding unit, a controller, a monitoring unit, and a second power feeding unit. The terminal is configured to connect a rechargeable battery. The first power feeding unit is configured to charge the rechargeable battery connected to the terminal. The controller is configured to control the first power feeding unit. The second power feeding unit is configured to feed electrical power to the controller and the monitoring unit. The monitoring unit includes a monitoring portion and a switching element. The monitoring portion is configured to monitor at least one of the rechargeable battery, the first power feeding unit, and the controller. The switching element is configured to interrupt the second power feeding unit to feed the electrical power to the monitoring portion.

The present invention further features a charging device. The charging device includes a terminal, an identifying unit, a charging unit, a threshold selecting unit, and a determining unit. The terminal is configured to connect a batter pack. The identifying unit is configured to identify a rated voltage of the battery pack connected to the terminal from among a plurality of rated voltages. The charging unit is configured to charge the battery pack connected to the terminal. The threshold selecting unit is configured to select a threshold value of the battery pack connected to the terminal from among a plurality of threshold values based on the identified rated voltage. The determining unit is configured to determine whether a battery voltage of the battery pack is less than the selected threshold value.

### Advantageous Effects of Invention

According to the present invention, the electrical power to the monitoring portion can be shutoff at an appropriate timing, thereby reducing power consumption.

Further, according to the present invention, the threshold value of the battery pack can be selected depending on the rated voltage. Accordingly, the over-discharged state of the battery pack can be properly determined.

### BRIEF DESCRIPTION OF DRAWINGS

FIG. 1 is a circuit diagram according to a first embodiment according of the present invention.

FIG. 2 is a flowchart illustrating a charging operation according to the first embodiment.

FIG. 3 is a circuit diagram according to a second embodiment of the present invention.

FIG. 4 is a flowchart illustrating a charging operation according to the second embodiment.

FIG. 5 is a circuit diagram according to a third embodiment of the present invention.

FIG. 6 is a flowchart illustrating a charging operation according to the third embodiment.

FIG. 7 is a flowchart illustrating a charging operation according to a modification of the third embodiment.

FIG. 8 is a circuit diagram according to a fourth embodiment of the present invention.

FIG. 9 is a flowchart illustrating a charging operation according to the fourth embodiment.

FIG. 10 is a circuit diagram according to a fifth embodiment of the present invention.

FIG. 11 is a flowchart illustrating a part of charging operation according to the fifth embodiment.

### DESCRIPTION OF EMBODIMENTS

### First Embodiment

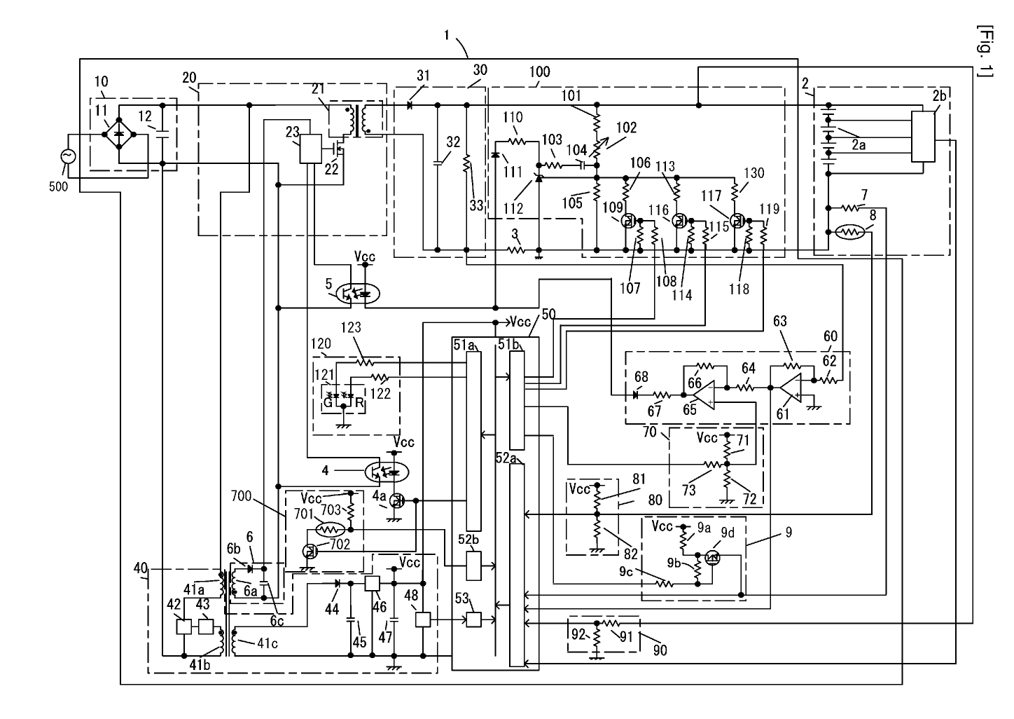

Hereinafter, a charging device 1 of a first embodiment of the present invention, and a battery pack 2 that is mounted on the charging device 1 will be described with reference to the accompanying drawings. FIG. 1 is a circuit diagram showing a situation where the battery pack 2 is mounted on the charging device 1. The battery pack 2 is used as a power source of a cordless tool, which is not shown in the diagram.

First, the battery pack 2 that is to be charged will be described. As shown in FIG. 1, the battery pack 2 includes a battery set in which a plurality of battery cells 2a are connected in series; a battery type identification resistor 7; a thermistor 8 that is a temperature sensing element; and a protection IC 2b. According to the present embodiment, an example of the battery pack 2 including lithium-ion battery cells 2a will be described. However, the type of battery cells to be charged is not specifically limited and any type of secondary battery may be used. The battery type identification resistor 7 has a unique resistance value that varies according to the type of the battery pack 2 (such as rated voltage or the number of battery cells that are connected in series). Based on the resistance value, the type of the battery pack, such as rated voltage and the number of battery cells 2a that are connected in series, can be determined. The thermistor 8 is so placed as to be in contact with the battery set, or near the battery set, to detect a temperature of the battery set. The protection IC 2b monitors voltage of each of the battery cells 2a, and prevents any one of the battery cells 2a from becoming unusual state (or error state) due to overcharge or over-discharge. As the battery cells 2b is charged, the voltage of the battery cells 2b increases. When the voltage has reached a threshold voltage indicative of full charge as a result of charging, the protection IC 2b outputs a signal corresponding to the full charge. Further, the protection IC 2b outputs a signal even when at least one of the battery cells 2a goes down to a threshold voltage (discharge limit voltage), because there is a risk that the battery cell 2a is over-discharged. In a state where the voltage has reached the threshold voltage indicative of full charge, a state where the voltage is less than or equal to the discharge limit voltage of the battery cells 2b, or a normal state, the protection IC 2b outputs signals corresponding to the states.

The battery pack 2 includes terminals that correspond to a charge plus terminal and charge minus terminal provided in the charging device 1, a temperature detection terminal, and a battery type information input terminal. As the battery pack 2 is mounted on the charging device 1, the terminals of the battery pack 2 are connected to the corresponding terminals of the charging device 1.

Then, the charging device 1 will be described. The charging device 1 includes a power source section, a microcomputer 50, various detection sections connected to input ports of the microcomputer 50, and controlled sections connected to output ports of the microcomputer 50.

The power source section includes a main power source that supplies charging power, and an auxiliary power source that applies drive voltage to the microcomputer 50. The main power source is a power source that charges the battery pack 2, and includes a first rectifying and smoothing circuit 10, a switching circuit 20, and a second rectifying and smoothing circuit 30.

The first rectifying and smoothing circuit 10 includes a full-wave rectifier circuit 11 and a smoothing capacitor 12. The full-wave rectifier circuit 11 full-wave rectifies an AC voltage supplied from an AC power source 500. The smoothing capacitor 12 smooths the voltage, and outputs a DC voltage. The AC power source 500 is an external power source such as a commercial power source.

The switching circuit 20 is connected to an output side of the first rectifying and smoothing circuit 10, and includes a high-frequency transformer 21, a MOSFET 22, and a PWM control IC 23. The PWM control IC 23 changes a drive pulse width inputted to the MOSFET 22. In accordance with the drive pulse width, the MOSFET 22 carries out switching, thereby converting a DC output from the first rectifying and smoothing circuit 10 into a voltage of pulse-train waveform. The voltage of pulse-train waveform is applied to a primary winding of the high-frequency transformer 21, and the voltage is stepped up (or down) by the high-frequency transformer 21 and then is outputted to the second rectifying and smoothing circuit 30.

The second rectifying and smoothing circuit 30 includes a diode 31, a smoothing capacitor 32, and a discharge resistor 33. The second rectifying and smoothing circuit 30 is configured to rectify and smooth an output voltage obtained from the secondary side of the high-frequency transformer 21 and generate a DC voltage, and output the DC voltage through the plus and minus terminals of the charging device 1.

The charging device 1 further includes an auxiliary power source 40 and a rectifying and smoothing circuit 6. The auxiliary power source 40 is a constant-voltage power supply circuit connected to the first rectifying and smoothing circuit 10 and the switching circuit 20 and receives power, and applies a stabilized reference voltage Vcc to various circuits such as the microcomputer 50 or operational amplifiers 61 and 65, which will be described later. The auxiliary power source 40 includes transformers 41a, 41b, and 41c, a switching element 42, a control element 43, a rectifying diode 44, a three-terminal regulator 46, oscillation prevention capacitors 45 and 47, and a reset IC 48. The reset IC 48 is an IC that outputs a reset signal to the microcomputer 50 at a time when the charging device 1 is connected to an AC power source.

The rectifying and smoothing circuit 6 is connected to the auxiliary power source 40 and the switching circuit 20, and serves as a power source of the PWM control IC 23. The rectifying and smoothing circuit 6 includes a secondary coil 6a of the transformer 41a, a rectifying diode 6b, and a smoothing capacitor 6c.

The microcomputer 50 includes a first output port 51a, a second output port 51b, A/D input ports 52 (52a and 52b), and a reset port 53. The microcomputer 50 processes various signals inputted to the A/D input ports 52, and outputs various resulting signals to each of the various controlled sections through the first output port 51a and the second output port 51b. In this manner, the microcomputer 50 controls the operation of the charging device 1.

The charging device 1 further includes a charging current setting circuit 70, a current detection resistor 3, a battery type determination circuit 9, a battery temperature detection circuit 80, a battery voltage detection circuit 90, a component temperature detection section 700, a charging current signal transmission section 5, a charging voltage control circuit 100, a charging current control circuit 60, a charging control signal transmission section 4 and a display section 120.

The second output port 51b includes a plurality of ports, one of which is connected to a charging current setting circuit 70.

The charging current setting circuit 70 includes resistors 71 and 72 that are connected in series between the reference voltage Vcc and the ground, and a resistor 73. The charging current setting circuit 70 sets a prescribed current value of the charging current. A connection point of the resistors 71 and 72 is connected to the resistor 73 and a non-inverting input terminal of the operational amplifier 65 in a charging control circuit 60. The resistor 73 is connected one port of the output port 51b.

According to the present embodiment, the charging current setting circuit 70 selectively sets one of two types of current values J1 and J2 as a set current for charging. More specifically, when a high signal is output from one of ports of the output port 51b connected to the resistor 73, a value obtained by dividing the reference voltage Vcc with the resistors 71 and 72 is used as a reference value for setting the set current as the current value J1. According to the present embodiment, the charging current value J1 is set to 3 A as one example.

As a low signal is output from one of ports of the second output port 51b connected to the resistor 73, a value obtained by dividing the reference voltage Vcc with the resistor 71 and parallel resistance of resistors 72 and 73 is used as a reference value for setting the set current as the current value J2. The charging current J2 is smaller than the charging current J1. According to the present embodiment, the charging current J2 is set to 1 A as one example.

As described above, the charging control circuit 60 is connected to the charging current setting circuit 70, and controls the charging current based on settings by the charging current setting circuit 70. The charging control circuit 60 includes the operational amplifiers 61 and 65, resistors 62, 63, 64, 66, and 67, and a diode 68. Incidentally, the A/D input port 52a includes a plurality of ports, one of which is connected to an output side of the operational amplifier 61.

The current detection resistor 3 is connected between the second rectifying and smoothing circuit 30 and a charging voltage control circuit 100, and detects the charging current flowing through the battery pack 2.

The A/D input port 52a of the microcomputer 50 includes a plurality of ports, which are respectively connected to the battery type determination circuit 9, a battery temperature detection circuit 80, and the battery voltage detection circuit 90.

The battery temperature detection circuit 80 includes resistors 81 and 82 connected in series between the reference voltage Vcc and the ground. A connection point of the resistors 81 and 82 is connected to the thermistor 8 of the battery pack 2, and to one of ports of the A/D input port 52a of the microcomputer 50. As the temperature of the battery set 2a of the battery pack 2 changes, a voltage value of the thermistor 8 corresponding to the temperature change is applied to a corresponding one of the ports of the A/D input port 52a of the microcomputer 50. In this manner, the charging device 1 can detect the temperature of the thermistor, that is, the temperature of the battery set 2a.

The battery voltage detection circuit 90 is connected to a plus terminal of the battery set when the battery pack 2 is mounted on the charging device 1. The battery voltage detection circuit 90 includes resistors 91 and 92. The voltage applied to the battery pack 2, or, the voltage of the battery pack 2, is divided by the resistors 91 and 92, and a value thereof is input as battery voltage information to one of the ports of the A/D input port 52a of the microcomputer 50. When no power is supplied to the battery pack 2, information indicative of the voltage of the battery pack 2 is input as battery voltage information to one of the ports of the A/D input port 52a via the battery voltage detection circuit 90. In the present invention, the battery voltage indicates a value one-to-one corresponding to a battery voltage that is actually detected from the battery pack 2, or a voltage of the actual battery.

The battery type determination circuit 9 includes resistors 9a, 9b, and 9c, and a FET 9d. A source of the FET 9d is connected to a terminal that is connected to the battery type identification resistor 7. A gate of the FET 9d is connected to one of the ports of the second output port 51b. As a low signal is output from one of the ports of the second output port 51b that is connected to the FET 9d, the FET 9d is turned ON. As a high signal is output from one of the ports of the second output port 51b that is connected to the FET 9d, the FET 9d is turned OFF. When the battery pack 2 is connected and when the FET 9d is ON, the microcomputer 50 identifies the type of the connected battery pack 2 (such as rated voltage or the number of battery cells that are connected in series) on the basis of a value obtained by dividing the reference voltage Vcc with the resistor 9a and the battery type identification resistor 7.

The first output port 51a of the microcomputer 50 includes a plurality of ports, which are respectively connected to the charging control signal transmission section 4 and the display section 120. The charging voltage control circuit 100 and the charging current setting circuit 70, and the battery type determination circuit 9 are connected to corresponding one of the ports of the second output port 51b of the microcomputer 50. The constant-voltage power supply circuit 40 is connected to the reset port 53.

The charging control signal transmission section 4 is connected to the switching circuit 20 and the microcomputer 50. The charging control signal transmission section 4 includes a photo coupler that transmits a signal for controlling a process of turning the PWM control circuit 23 ON/OFF, and a FET 4a that is connected to a light-emitting element in the photo coupler 4 and controls a process of turning the light-emitting element ON/OFF. The first output port 51a includes a plurality of ports, one of which is connected to a gate of the FET 4a. When a high signal is output from one of the ports of the output port 51a that is connected to the FET 4a, the FET 4a is turned ON, and the photo coupler 4 is turned ON. As a result, the PWM control circuit 23 is activated, and the charging starts. When a low signal is output from one of the ports of the output port 51a that is connected to the FET 4a, the FET 4a is turned OFF, and the photo coupler 4 is turned OFF. As a result, the PWM control circuit 23 is stopped, and the charging is stopped (or ended).

The component temperature detection section 700 includes a resistor 703, a thermistor 701, and a FET 702. The resistor 703, the thermistor 701, and the FET 702 are connected between the reference voltage Vcc and the ground. A connection point of the resistor 703 and thermistor 701 is connected to the A/D input port 52b. A gate of the FET 702 is connected to one of the ports of the first output port 51a that is also connected to the FET 4a. That is, one of the ports of the first output port 51a is shared by the FET 4a and the FET 702. Therefore, the process of turning the FET 702 ON/OFF is in synchronization with the process of turning the FET 4a ON/OFF. Only during the charging, the thermistor 701 is driven, that is, the electrical power is supplied to the thermistor, and an internal temperature of the charging device 1 is detected. That is, as a high signal is output from one of the ports of the first output port 51a that is connected to the gates of the FET 702 and FET 4a, the FET 702 is turned ON, and current flows from the reference voltage Vcc to the resistor 703 and the thermistor 701. At this time, the microcomputer 50 determines the temperature of the thermistor 701 based on a value obtained by dividing the reference voltage Vcc with the resistor 703 and the thermistor 701. As a low signal is output from a port a of the first output port 51a connected to the gates of the FET 702 and FET 4a, the FET 702 is turned OFF, and the current from the reference voltage Vcc to the resistor 703 and the thermistor 701 is blocked. The thermistor 701 is so placed as to be in contact with a component that generates heat in the charging device 1 and is likely to rise in temperature, or near the component. In one example, according to the present embodiment, the thermistor 701 is placed near the PWM control circuit 23.

The charging current signal transmission section 5 is connected to the switching circuit 20, the charging voltage control circuit 100, and the charging current control circuit 60. The charging current signal transmission section 5 includes a photo coupler that feeds a signal of the charging current back to the PWM control IC 23.

The display section 120 is a circuit for displaying a charging state, and includes a LED 121 and resistors 122 and 123. When a high signal is output from one of the ports of the first output port 51a connected to the resistors 122, the LED 121 emits red light. When a high signal is output from one of the ports of the first output port 51a connected to the resistors 123, the LED 121 emits green light. When a high signal is output from both the ports, the LED 121 emits orange light. According to the present embodiment, the microcomputer 50 controls the LED 121 to emit red light before the charging starts, such as when the battery pack 2 is not connected or when the device is in a charging standby mode. The microcomputer 50 controls the LED 121 to emit orange light during the charging by simultaneously turning on two light-emitting elements of the LED 121. After the charging is completed, the microcomputer 50 controls the LED 121 to emit green light.

The charging voltage control circuit 100 is connected to the second rectifying and smoothing circuit 30, and controls the charging voltage. The charging voltage control circuit 100 includes resistors 101, 103, 105, 106, 107, 108, 110, 111, 113, 114, 115, 118, 119, and 130, a potentiometer 102, FETs 109, 116, 117, a capacitor 104, a shunt regulator 112, and a rectifier diode 111. The resistors 108, 115, and 119 are respectively connected to a plurality of ports that the second output port 51b has. Based on a signal from the second output port 51b of the microcomputer 50, the charging voltage is set by setting a reference value of the shunt regulator 112 to a voltage value divided by the series resistance of the resistor 101 and potentiometer 102 and the parallel resistance of the resistor 105 and any one of resistors 106, 113, and 130. For example, a value determined by the series resistance of the resistor 101 and potentiometer 102 and only the resistor 105 (when the FETs 109, 116, 117 all are OFF) is used to charge a two-cell lithium-ion battery. A value determined by the series resistance (101, 102) and the parallel resistance of the resistors 105 and 106 (or the parallel resistance at a time when the FET 109 is turned ON) is used to charge a three-cell lithium-ion battery. Similarly, a four-cell lithium-ion battery is supported when the FET 116 is ON; a five-cell lithium-ion battery is supported when the FET 117 is ON.

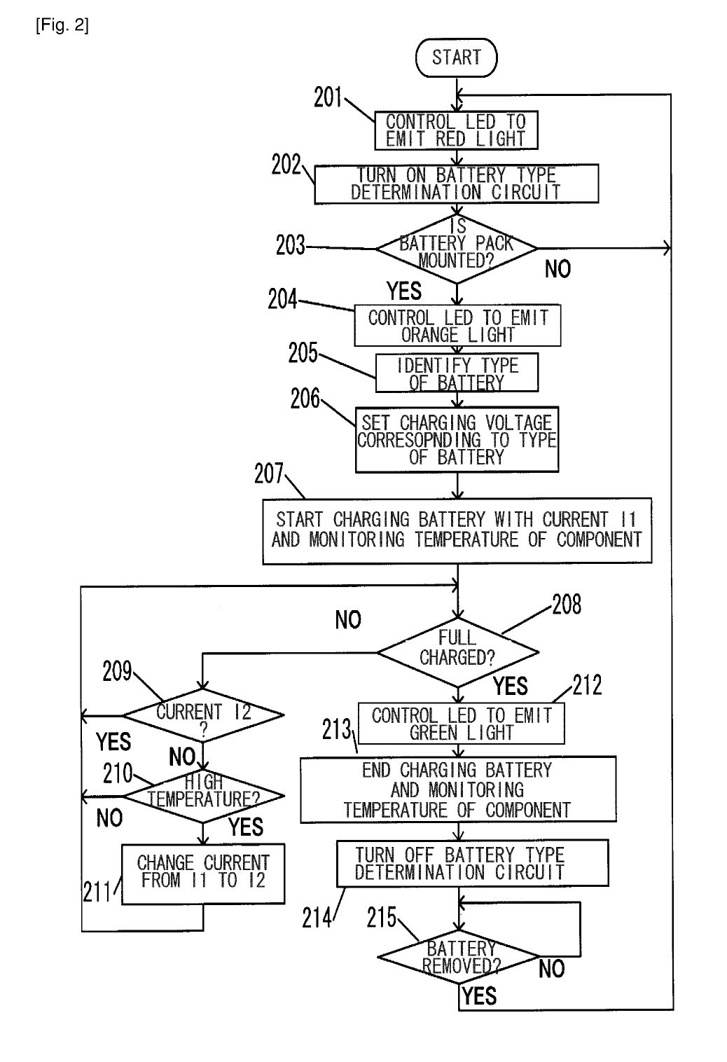

With reference to a flowchart of FIG. 2, a charging process by the charging device 1 will be described. In Step S201, the microcomputer 50 outputs a high signal from one of the ports of the first output port 51a connected to the resistors 122, thereby controlling the LED 121 to emit the red light and notifying a user of the fact that the charging is not yet started. In Step 202, the microcomputer 50 outputs a low signal from one of the ports of the second output port 51b connected to the resistor 9c, thereby turning the FET 9d ON and supplying the current from the reference voltage Vcc to the battery type determination circuit 9. In Step 203, the microcomputer 50 determines whether the battery pack 2 is mounted on the charging device 1. The determination is made by determining whether a signal is input from the battery temperature detection circuit 80, the battery type determination circuit 9, and the battery voltage detection circuit 90 to corresponding ports of the A/D input port 52a. When the inputting is detected in the circuits, the microcomputer 50 determines that the battery pack 2 has been mounted. When a negative determination is made in Step S203 (S203: NO), the process goes back to step S201, and the device then is in a standby mode. When an affirmative determination is made in Step S203 (S203: YES), the microcomputer 50 in Step 204 outputs a high signal to both the ports of the output port 51a connected to the resistors 123 and 122, thereby controlling the LED 121 to emit the orange light and notifying a user of the fact that the battery pack 2 is in the process of being charged.

In Step 205, based on a value obtained by dividing the reference voltage Vcc with the resistor 9a of the battery type determination circuit 9 and the battery type identification resistor 7, the microcomputer 50 identifies the type of the connected battery pack 2 (such as rated voltage or the number of battery cells that are connected in series). In Step 206, based on the number of cells of the battery pack 2 that are identified, the microcomputer 50 sets the charging voltage of the charging voltage control circuit 100. More specifically, the microcomputer 50 identifies that the battery cells 2a that are connected in series in the charging pack are lithium-ion batteries, and identifies the number of battery cells connected in series. The microcomputer 50 sets the charging voltage based on those identified information, and controls the driving of the FETs 109, 116, and 117, as described above, in accordance with the number of battery cells connected in series in order to set the prescribed charging voltage.

In Step S207, the microcomputer 50 outputs a high signal from one of the ports of the first output port 51a connected to the gate of the FET 4a, thereby activating the PWM control circuit 23. As a result, the process of charging the battery pack 2 is started. In response to a high signal from one of the ports of the first output port 51a connected to the gate of the FET 4a, the FET 702 is simultaneously turned ON. As a result, the thermistor 701 is activated, and a voltage corresponding to the temperature of the thermistor 701 is input to the A/D input port 52b. The microcomputer 50 starts monitoring the internal temperature of the charging device 1 through the thermistor 701.

In Step 208, the microcomputer 50 determines whether the battery pack 2 is fully charged. For example, one way to make the determination is to invert and amplify the potential detected by the current detection resistor 3 by using the operational amplifier 61, and input the potential to a corresponding port of the A/D port 52a, thereby monitoring the charging current. According to the present embodiment, as one example of charging control, a constant current &#8211; constant voltage control method is performed. That is, the charging is started in a constant current mode. As the battery is charged, the voltage of the battery rises. When the voltage has reached a predetermined voltage, a constant-voltage charging mode is started. During a constant-voltage charging period, as the charging is carried out, the current decreases. Therefore, when the current value is less than or equal to a predetermined value, it is determined that the battery is fully charged. According to the present embodiment, while the details will be given later, depending on the internal temperature of the charging device 1, two types of current values J1 (e.g. 6 A) and J2 (e.g. 3 A) are set as the charging current. Therefore, the predetermined value varies according to the type of the current value that is set as the charging current. For example, in the case of the current value J1, a terminal current value is 3 A in one example whereas in the case of the current value J2, the terminal current value is 1 A. The terminal current values may be equal for two types of current values J1 and J2 (e.g. 1 A). The above constant current—constant voltage control method is one example of the charging control method. Any other charging methods that are used for charging secondary batteries may be employed, such as those featuring only constant-voltage control or constant-current control.

In Step 208, the microcomputer 50 determines whether or not the battery is fully charged. When a negative determination is made in Step 208 (S208: NO), the microcomputer 50 in Step 209 determines whether the current value J2 is set by the charging current setting circuit 70 as the set current. When an affirmative determination is made in Step 209 (S209: YES), the charging continues with the current value J2, and the process returns to step 208. When a negative determination is made in Step 209 (S209: NO), the microcomputer 50 determines, by using the thermistor 701, whether the temperature of the charging device 1 is greater than or equal to a predetermined value. When a negative determination is made in Step 210 (S210: NO), the charging continues with the current value J1, and in Step 208 the microcomputer 50 determines again whether the battery is fully charged. When an affirmative determination is made in Step 210 (S210: YES), in Step 211 the microcomputer 50 changes the set current of the charging current setting circuit 70 to the current value J2, which is smaller than the current value J1, in order to reduce a rise in the internal temperature of the charging device 1.

When an affirmative determination is made in Step 208 (S208: YES), or when it is determined that the battery is fully charged, the microcomputer 50 in Step 212 controls the LED 121 to emit the green light, notifying a user of the fact that the charging is completed.

In Step 213, in response to the full-charge detection in Step 208, the microcomputer 50 outputs a low signal from the first output port 51a and turns the FETs 4a and 202 OFF. As a result, the charging is ended. The current from the reference voltage Vcc to the resistor 703 and the thermistor 701 is blocked, thereby reducing power consumption by the thermistor 701.

In Step 214, a low signal is output from one of the ports of the second output port 51b connected to the FET 9d, and turns the FET 9d OFF. As a result, the current from the reference voltage Vcc to the resistor 9a and the battery type identification resistor 7 is blocked, thereby reducing power consumption. The FET 9d may be turned OFF not only in Step 214 of the present embodiment, but at any time after the type of the battery is identified in Step S205.

In Step 215, the microcomputer 50 determines whether the battery pack 2 is removed. The microcomputer 50 waits until the battery pack 2 is removed. After the battery pack 2 is removed (S215: YES), the charging conditions are reset, and the process returns to step 201. Incidentally, even if the battery pack 2 is removed from the charging device 1 at a timing not shown in the flowchart, as in the case of the above step 215, the charging device resets a series of charging conditions, goes back to step S201, and waits.

The above charging device 1 can turn the FET 9d OFF at any given time after the process 205 of determining the type of the battery, thereby blocking the current flowing through the battery type determination circuit 9. In this manner, after the type of the battery pack 2 is determined, the route from the reference voltage Vcc to the ground via the battery type determination circuit 9 is cut off to further reduce power consumption by the charging device 1.

Moreover, the FET 702 that controls the thermistor 701 is turned ON and OFF in synchronization with the FET 4a that controls the charging. Therefore, when the charging is not carried out, the current flowing through the resistor 703 and the thermistor 701 can be blocked. Therefore, power consumption when the device is in a standby mode can be reduced in a more effective manner.

To reduce power consumption when the device is in a standby mode, in addition to the battery type determination circuit 9 and the component temperature detection section 700, which are illustrated in the above embodiment, a FET for cutting off a circuit may be provided for other circuits included in the charging device 1. For example, a FET may be provided for the battery temperature detection circuit 80 or the battery voltage detection circuit 90. When the charging is not carried out, the battery temperature detection circuit 80 connected to the thermistor 8 of the battery pack 2, or the battery voltage detection circuit 90 connected to a charging terminal of the battery pack 2 may be cut off. More specifically, as in the case of the battery type determination circuit 9 or the component temperature detection section 700, a FET is provided at a position where a current path can be cut off (for example, a position between the reference voltage Vcc and the resistor 81, the position between the resistors 81 and 82, or one of end positions of the resistor 91). In response to a control signal from the output port 51a or 51b of the microcomputer 50, the FET is preferably so controlled as to be turned ON only when necessary. This configuration can reduce power consumption in a more effective manner.

When a plurality of positions where temperatures are detected are required in the charging device 1, a plurality of component temperature detection sections 700 may be provided. In this case, between the gate of the FET 4a and a corresponding port of the first output port 51a, a plurality of component temperature detection sections 700 may be connected in parallel. Alternatively, the plurality of FETs may be provided and connected to the plurality of component temperature detection sections 700. The microcomputer 50 may output different control signals to drive the component temperature detection sections 700 separately by controlling each of the plurality of FETs.

### Second Embodiment

Next, a second embodiment of the charging device 1 will be described. The following description of the second embodiment will focus on points of difference from the first embodiment, wherein like parts and components are designated with the same reference numerals to avoid duplicating description.

In the second embodiment, the protection IC 2b outputs a high signal for a normal working voltage when the battery pack 2 is neither over-discharged nor fully charged. In an unusual or error state such as when the over-discharge or full-charge is informed, the protection IC2b outputs a low signal such as ground voltage.

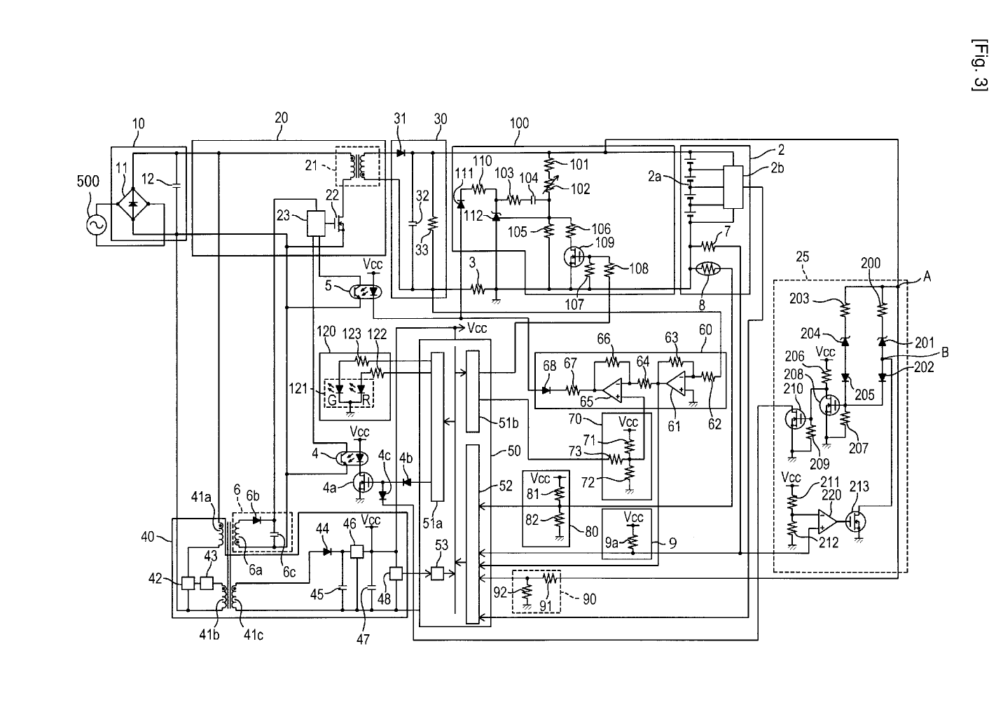

As shown in FIG. 3, in the second embodiment, the charging device 1 does not includes the component temperature detection section 700. The microcomputer 50 does not includes the A/D input port 52b. Because the A/D input port 52b is not included, the A/D input port 52a is denoted simply the A/D input port 52 in the following description.

In the second embodiment, the battery type determination circuit 9 includes the reference resistor 9a positioned between the power supply voltage Vcc and the A/D input port 52. In the second embodiment, the battery type determination circuit 9 does not include resistors 9b, and 9c, and a FET 9d. When the battery pack 2 is mounted, the battery type identification resistor 7 and the reference resistor 9a of the battery type determination circuit 9 are connected in series. A divided voltage obtained by dividing the power supply voltage Vcc with the resistor 9a and the battery type identification resistor 7 is input to the microcomputer 50 (the A/D input port 52a). Based on the divided voltage value, the microcomputer 50 determines the type of the connected battery pack 2 (such as rated voltage or the number of battery cells that are connected in series).

The charging control signal transmission section 4 is connected to the switching circuit 20 and the microcomputer 50. The charging control signal transmission section 4 includes a photo coupler 4 that transmits a signal for controlling a process of turning the PWM control circuit 23 ON/OFF, and a FET 4a that is connected to a light-emitting element making up the photo coupler 4 and controls a process of turning the light-emitting element ON/OFF. The gate of the FET 4a is connected to the first output port 51a via a diode 4b. When a high signal is output from the output port 51a, the FET 4a is turned ON, and the photo coupler 4 is turned ON. As a result, the PWM control circuit 23 is activated, and the charging starts. When a low signal is output from the output port 51a, the FET 4a is turned OFF, and the photo coupler 4 OFF. As a result, the PWM control circuit 23 is stopped, and the battery charge is stopped. Furthermore, when a FET 210 of a threshold voltage setting circuit 25, which will be detailed later, is turned ON, a high signal that is output from the output port 51a is not input to the FET 4a, but is supplied to the ground via the diode 4c and the FET 210. As a result, the FET 4a is not driven, and the photo coupler 4 is turned OFF. Accordingly, the PWM control circuit 23 is stopped, and the battery charge is stopped.

The charging voltage control circuit 100 is connected to the second rectifying and smoothing circuit 30, and controls the charging voltage. The charging voltage control circuit 100 includes resistors 101, 103, 105, 106, 107, 108, and 110, a potentiometer 102, a FET 109, a capacitor 104, a shunt regulator 112, and a rectifier diode 111. In the second embodiment, the charging voltage control circuit 100 does not include resistors 113, 114, 115, 118, 119, and 130, FETs 109, 116, 117. Based on a signal from the second output port 51b of the microcomputer 50, the charging voltage is set by setting a reference value of the shunt regulator 112 to a voltage value divided by the series resistance of the resistor 101 and the potentiometer 102 and the parallel resistance of the resistors 105 and 106.

In the second embodiment, the charging device 1 further includes a threshold voltage setting circuit 25.

The threshold voltage setting circuit 25 includes an operational amplifier 220, resistors 200, 203, 206, 207, 209, 211, and 212, FETs 208, 210, and 213, zener diodes 201 and 204, and diodes 202 and 205. The threshold voltage setting circuit 25 determines whether or not the battery pack 2 is being over-discharged. The two zener diodes 201 and 204 has breakdown voltages (zener voltages) different from each other. According to this configuration, two discharge limit voltages are set in the threshold voltage setting circuit 25. Here, the discharge limit voltages are used for determining an over-discharge state that depends on the rated voltage of the battery pack 2 mounted on the charging device 1.

The threshold voltage setting circuit 25 is provided between the reference potential (hereinafter, the reference potential indicates ground potential) and a node A. The battery voltage of the battery pack 2 is an input voltage of the threshold voltage setting circuit 25. That is, the battery voltage of the battery pack 2 applies between the node A and the reference potential.

As a route for a first threshold voltage, the following components are sequentially connected in series in the following order from a high potential side (the node A) to the reference potential: the resistor 200, the zener diode 201, the diode 202, and the resistor 207. A cathode of the zener diode 201 is connected to the resistor 200, and an anode of the zener diode 201 is connected to an anode of the diode 202 at a node B. A zener voltage V1 of the zener diode 201 corresponds to a discharge limit threshold voltage of the battery pack 2 when five battery cells of the battery pack 2 are connected in series, for example. According to the present embodiment, the zener voltage V1 is 9V for example.

In the threshold voltage setting circuit 25, as a route for a second threshold voltage, the following components are sequentially connected in series in the following order from a high potential side (node A) to the resistor 207: the resistor 203, the zener diode 204, and the diode 205. The route for the second threshold voltage is parallel to the rout for the first threshold voltage. A cathode of the zener diode 204 is connected to the resistor 203, and an anode of the zener diode 204 is connected to an anode of the diode 205. A zener voltage V4 of the zener diode 204 has a value that is higher than the zener voltage of the zener diode 201. The zener voltage V4 corresponds to a discharge limit threshold voltage of the battery pack 2 when ten battery cells of the battery pack 2 are connected in series, or 18V, for example.

Furthermore, the resistor 206 and the FET 208 are sequentially connected in series and in this order from the power supply voltage Vcc to the reference potential. A drain of the FET 208 is connected to the resistor 206, and a source of the FET 208 to the reference potential, and a gate of the FET 208 to a connection point of the diode 205 and resistor 207.

A drain of the FET 210 is connected to the first output port 51a of the microcomputer 50 via the diodes 4b and 4c as an output of the threshold voltage setting circuit 25. Here, the diode 4c prevents a backward current flowing from the threshold voltage setting circuit 25 to the microcomputer 50. A source of the FET 210 is connected to the reference potential, the gate of the FET 210 to a connection point of the drain of the FET 208 and the resistor 206.

In the threshold voltage setting circuit 25, the operational amplifier 220 is a logical operation circuit. A divided voltage obtained by dividing the power supply voltage Vcc with the battery type identification resistor 7 of the battery pack 2 and the reference resistor 9a is input to a non-inverting terminal of the operational amplifier 220. A divided voltage obtained by dividing the power supply voltage Vcc with the resistors 211 and 212 is input to the inverting terminal of the operational amplifier 220, as a reference. Therefore, the operational amplifier 220 determines whether the electric potential between the register 9a and the battery type identification resistor 7 of the mounted battery pack 2 (the potential of the non-inverting terminal) is larger or smaller than the reference of the operational amplifier 220. If a high-rated-voltage battery pack 2 in which ten cells are connected in series is mounted, the battery type identification resistor 7 has a relatively large resistance value of 1,000 (kilo ohm) as one example. Therefore, a voltage higher than the reference of the operational amplifier 220 is input to the non-inverting terminal, and the operational amplifier 220 outputs a high signal. If a low-rated-voltage battery pack 2′ in which five cells are connected in series is mounted, the battery type identification resistor 7 has a smaller resistance value than that of the above battery pack 2, e.g. 500 (kilo ohm). Therefore, a voltage lower than the reference voltage is input to the non-inverting terminal, and the operational amplifier 220 outputs a low signal.

An output terminal of the operational amplifier 220 is connected to the gate of the FET 213. A drain of the FET 213 is connected to the connection point of the anode of the zener diode 201 and the anode of the diode 202, and a source of the FET 213 is connected to the reference potential. Accordingly, when a signal output from the operational amplifier 220 is a high signal, the FET 213 is turned ON. When the signal is a low signal, the FET 213 is turned OFF. That is, according to the present embodiment, when the battery pack 2 is a low-rated-voltage battery pack 2′ in which five battery cells 2a are connected in series, the FET 213 is turned OFF. When the battery pack 2 is a high-rated-voltage battery pack 2 in which ten battery cells 2a are connected in series, the FET 213 is turned ON. As a result, the route that defines the second threshold value of a low rated voltage (the route including the zener diode 201) does not contribute to control of the FET 208 because the route is connected to the ground via the node B and the FET 213.

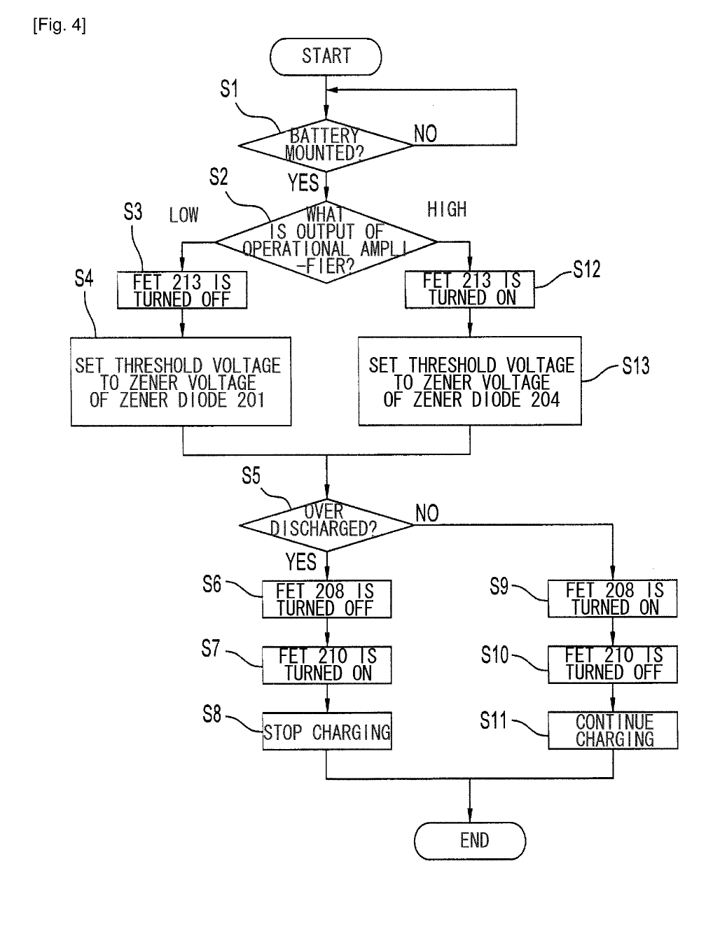

The operation of the charging device 1 will be described with reference to FIGS. 3 and 4.

First, the case where a low-rated-voltage battery pack is connected to the charging device 1 will be described. After the battery pack 2 is mounted on the charging device 1 (Step S1: YES), the battery type identification resistor 7 of the battery pack 2 is connected in series to the reference resistor 9a of the charging device 1. In the threshold voltage setting circuit 25, a divided voltage obtained by dividing the power supply voltage Vcc with the battery type identification resistor 7 and the reference resistor 9a is input to the non-inverting input terminal of the operational amplifier 220. At this time, if the number “a” of battery cells 2a connected in series is five, the value of the divided voltage is smaller than the reference, and the operational amplifier 220 therefore outputs a low signal (Step S2: Low). In response to the low signal output from the operational amplifier 220, in Step S3 the FET 213 is turned OFF. At this time, a voltage corresponding to the battery voltage is applied to the zener diodes 201 and 204. Therefore, the FET 208 is turned ON/OFF depending on the magnitude relation between the zener voltage V1 of the zener diode 201 and the battery voltage. The reason is that the zener voltage V1 of the zener diode 201 is smaller than the zener voltage V4 of the zener diode 204. That is, in Step S4 the threshold voltage setting circuit 25 sets the threshold voltage to the zener voltage of the zener diode 201. Therefore, the battery voltage corresponding to the zener diode 201 with a low breakdown voltage (zener voltage) is used as a threshold value in controlling the FET 208.

According to the above configuration, the breakdown voltage V1 of the zener diode is used as a threshold voltage to determine a discharge limit of the battery pack 2, and the threshold voltage setting circuit 25 determines whether or not an over-discharge state exists. When the battery voltage is less than the breakdown voltage V1 of the zener diode 201, i.e. when the battery pack 2 is less than or equal to the discharge limit voltage (Step S5: YES), in Step S6 the FET 208 is turned OFF, and in Step S7 the FET 210 is turned ON. As a result, in the charging control signal transmission section 4, a high signal output from the output port 51a is supplied to the ground via the diode 4c and the FET 210, thereby blocking an input to the FET 4a. Therefore, even if the charging of the battery pack 2 already has started, in Step S8 the battery charge is immediately stopped. Here, the breakdown voltage of the zener diode 204 is higher than the breakdown voltage of the zener diode 201. Therefore, at voltage V1, the route going through the zener diode 204 does not become conductive, making no contribution to the control of the FET 208.

When the battery voltage is greater than or equal to the zener voltage V1 (Step S5: NO), the battery pack 2 is not in an over-discharge state, and thus in Step S9 the FET 208 is turned ON, and in Step S10 the FET 210 is turned OFF. As a result, the threshold voltage setting circuit 25 is disconnected from the charging control signal transmission section 4, and the output port 51a outputs a high signal. If the charging process of the battery pack 2 is started, in Step S11 the charging continues. If the battery voltage is higher than the breakdown voltage V4 of the zener diode 204, the route of the zener diode 201, as well as the route of the zener diode 204, becomes conductive. Through any of the routes, the FET 208 should be driven.

On the other hand, if a high-rated-voltage battery pack is connected, i.e. if the number “a” of battery cells 2a connected in series is ten in Step S2, a value of the divided voltage obtained by dividing the power supply voltage Vcc with the battery type identification resistor 7 and the reference resistor 9a is larger than the reference, and the operational amplifier 220 therefore outputs a high signal (Step S2: High). In response to the high signal from the operational amplifier 220, the FET 213 is turned ON (step S12). As the FET 213 is turned ON, as described above, the route of the zener diode 201 is connected to the ground via the FET 213. As a result, the zener diode 204 becomes dominant for the process of turning the FET 208 ON/OFF. Therefore, in Step S13 the threshold value of the battery voltage is dependent on the zener voltage V4 of the zener diode 204. After Step S13, as in the case of the above low-rated-voltage battery pack, a comparison is made between the battery voltage and the zener voltage of the zener diode 204 to determine whether the charging should be stopped or continue (Steps S5 to 11).

As described above, the threshold voltage setting circuit 25 sets the threshold value of the battery voltage based on the number of battery cells 2a. The number of battery cells 2a indicates the rated voltage of the battery pack 2. Thus, the threshold voltage setting circuit 25 sets the threshold value of the battery voltage based on the rated voltage of the battery pack 2.

Accordingly, in the case where the low-rated-voltage battery pack 2 is mounted to the charging device 1, the zener voltage of the zener diode 201 can be used as a threshold voltage. In the case where the high-rated-voltage battery pack 2 is mounted to the charging device 1, the zener voltage of the zener diode 204, which is higher than that of the zener diode 201, can be used as a threshold voltage. That is, in accordance with the rated voltage of the battery pack 2 (or the number of cells connected in series), a discharge-limit threshold voltage for determining whether or not an over-discharge state exists can be selectively set.

### Third Embodiment

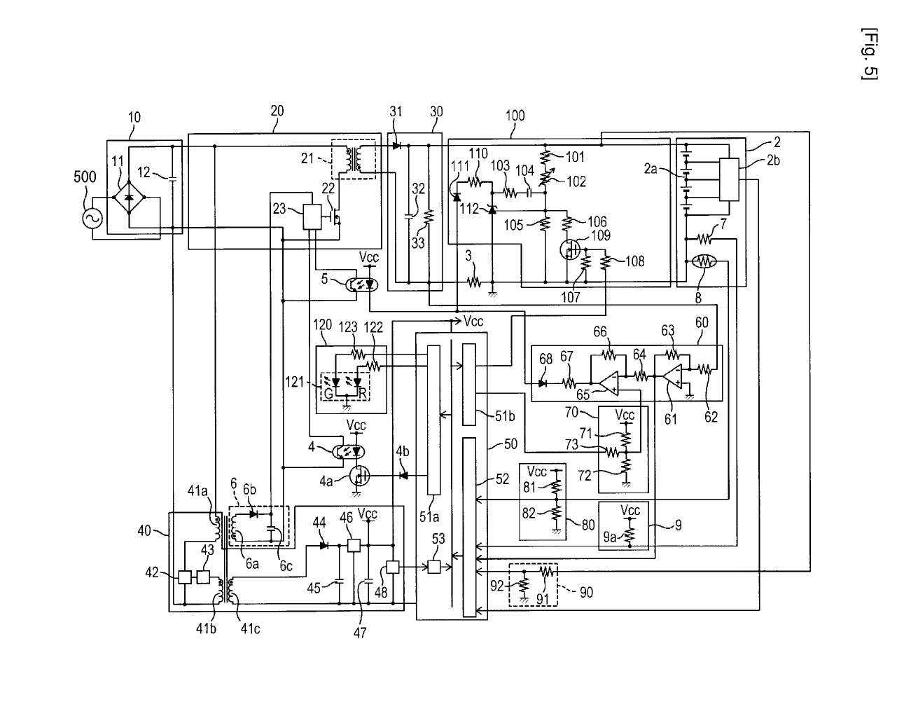

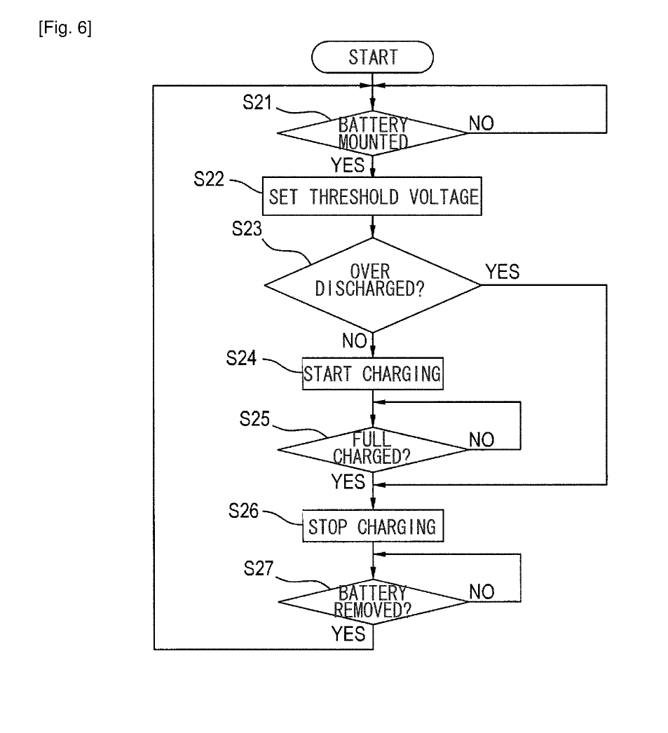

A third embodiment of the present invention will be described with reference to FIGS. 5 and 6. The following description of the third embodiment will focus on points of difference from the second embodiment. In the second embodiment, the threshold voltage setting circuit 25 has a plurality of zener diodes of different breakdown voltages which is used to set a threshold voltage. However, the present invention is not limited thereto. According to the third embodiment, instead of the threshold voltage setting circuit 25, the microcomputer 50 of a charging device 1 determines whether or not an over-discharge state of a battery pack 2 exists. Therefore, in the charging device 1 shown in FIG. 5, the function of the threshold voltage setting circuit 25 is incorporated into the microcomputer 50, and the charging device 1 does not includes the threshold voltage setting circuit 25. The configuration of the other portions is the same as that of the charging device 1 shown in FIG. 3.

The operation of the charging device 1 shown in FIG. 5 will be described with reference to FIG. 6. In the operation of the charging device 1 shown in FIG. 6, when the microcomputer 50 determines that the battery voltage of the battery pack 2 is less than or equal to a discharge limit voltage, the charging of the battery pack 2 is not carried out.

First, when the battery pack 2 is mounted on the charging device 1 (Step S21: YES), the microcomputer 50 reads, from a battery type identification resistor 7 of the battery pack 2, the number of lithium-ion batteries connected in series in the battery pack 2 and a rated voltage. Based on the rated voltage of the battery pack 2 that is read, in Step S22 the microcomputer 50 sets a threshold voltage of discharge limit used to determine whether the battery pack 2 is in an over-discharge state. For example, in the case where a battery pack with a rated voltage of 14V in which five lithium-ion batteries are connected in series is mounted to the charging device 1, the threshold voltage is set to 9V. In the case where a battery pack with a rated voltage of 36V in which ten lithium-ion batteries are connected in series is mounted to the charging device 1, the threshold voltage is set to 18V.

In Step S23 the microcomputer 50 compares the battery voltage of the battery pack 2 detected by the battery voltage detection circuit 90 to the threshold voltage, and determines whether or not the battery pack 2 is in an over-discharge state. When the battery pack with a rated voltage of 14V is mounted, the microcomputer 50 compares the battery voltage with the threshold voltage of 9V. When the battery pack with a rated voltage of 36V is mounted, the microcomputer 50 compares the battery voltage is compared with threshold voltage of 18V. That is, the microcomputer 50 compares the threshold voltage that is set in accordance with the rated voltage of the battery pack with the actual battery voltage. If the battery voltage is less than or equal to the threshold voltage (Step S23: YES), the microcomputer 50 determines that the battery pack 2 is in an over-discharge state, and in Step S26 the battery charge is not carried out (ended). If the battery voltage is greater than the threshold voltage (Step S23: NO), in Step S24 the microcomputer 50 starts charging the battery pack 2.

When the charging of the battery pack 2 continues, and the microcomputer 50 determines, based on the battery voltage detected by the battery voltage detection circuit 90, that the battery pack 2 is fully charged (Step S25: YES), then in Step S26 the charging of the battery pack 2 is ended. If the battery pack 2 is not yet fully charged (Step S25: NO), the microcomputer 50 continues the charging until the battery pack 2 is fully charged. After the battery pack 2 is removed from the charging device 1 (Step S27: YES), the microcomputer 50 waits for the next battery pack 2 to be mounted. Although not shown in the flowchart, when the battery pack 2 is removed from the charging device 1 prior to step S27, the charging device 1 resets the conditions, and enters a standby mode to wait for the next battery pack 2 to be mounted.

In that manner, the threshold voltage which is a discharge limit voltage for determining whether the battery pack 2 is in an over-discharge state can be changed according to the rated voltage of the battery pack 2. Therefore, one charging device 1 can properly set the threshold value of the discharge limit voltage corresponding to the rated voltage of the battery pack 2 mounted to the charging device 1, thereby increasing the life of the battery pack 2.

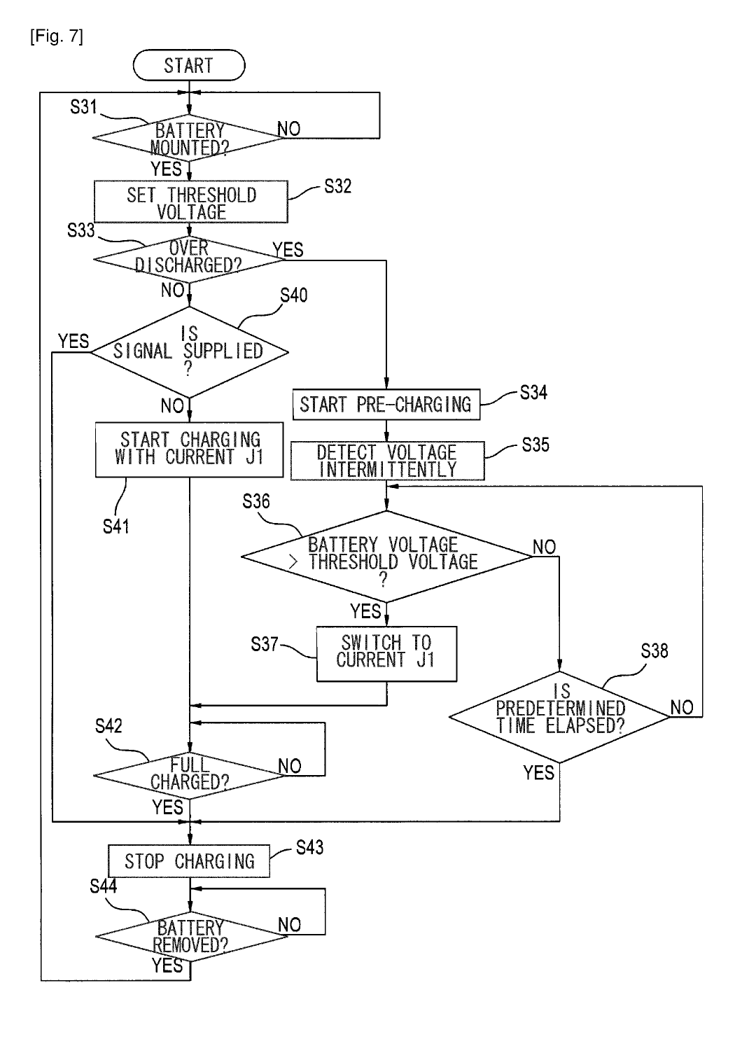

Next, a modified example of the charging operation of the charging device 1 shown in FIG. 5 will be explained with reference to FIG. 7. In the modified example, the charging device 1 pre-charges a battery pack 2 if the charging device 1 estimates that the battery pack 2 is in the over-discharge state, that is, the battery voltage of the battery pack 2 is less than or equal to the discharge limit voltage. Subsequently, the charging device 1 determines whether or not the charging should continue based on a progression or result of the pre-charging, that is, based on how the pre-charging is performed.

First, when the battery pack 2 is mounted on the charging device 1 (Step S31: YES), the microcomputer 50 reads, from a battery type identification resistor 7 of the battery pack 2, the number of lithium-ion batteries connected in series in the battery pack 2 and a rated voltage. Based on the rated voltage of the battery pack 2 that is read, in Step S32 the microcomputer 50 sets a threshold voltage of discharge limit used to determine whether the battery pack 2 is in an over-discharge state. For example, in the case where a battery pack with a rated voltage of 14V in which five lithium-ion batteries are connected in series is mounted to the charging device 1, the threshold voltage is set to 9V. In the case where a battery pack with a rated voltage of 36V in which ten lithium-ion batteries are connected in series is mounted to the charging device 1, the threshold voltage is set to 18V.

Then, in Step S33 the microcomputer 50 compares the battery voltage of the battery pack 2 detected by the battery voltage detection circuit 90 with the threshold voltage corresponding to the rated voltage. That is, the microcomputer 50 compares the threshold voltage with the actual battery voltage, and determines whether or not the battery pack 2 is less than or equal to the discharge limit voltage. When the battery voltage is less than or equal to the threshold voltage (Step S33: YES), the battery pack 2 is probably in an over-discharge state. Thus, instead of normal charging conditions, in Step S34 the microcomputer 50 starts pre-charging of the battery pack 2. Here, the pre-charging is a charging method performed when degradation of battery performance is anticipated. The degradation of battery performance is occurred when the battery voltage of the battery pack 2 is less than or equal to the discharge limit voltage, for example. Compared with the normal battery charge performed when the battery pack 2 is not in an over-discharge state, the pre-charging is performed under “mild” charging conditions that low current flows to the battery pack 2 or low voltage is applied to the battery pack 2, for example. In the present embodiment, the microcomputer 50 sets the charging current to J1 when performing normal charging and sets the charging current to J2 that is lower than J1 when performing pre-charging.

After the pre-charging of the battery pack 2 is started, in Step S35 the microcomputer 50 continuously or intermittently detects the battery voltage of the battery pack 2 while performing pre-charging. If the detected battery voltage is greater than the threshold voltage (Step S36: YES), in Step S37 the microcomputer 50 judges that the battery pack 2 is normal, and continues the battery charge after switching to the charging current J1 that is larger than the charging current J2, and proceeds to Step S42.

If the detected battery voltage is not greater than the threshold voltage (Step S36: NO), the microcomputer 50 proceeds to Step S38, and in Step S38 determines whether or not a predetermined time has elapsed since the pre-charging is started. If the predetermined time already has elapsed (Step S38: YES), it is suspected that the battery cells have run into some trouble, and in Step S43 the microcomputer 50 stops the battery charge. If the predetermined time has not yet elapsed since the pre-charging is started (Step S38: NO), the process returns to Step S36. Thus, Step S36 is repeated, and the microcomputer continues monitoring of the battery voltage of the battery pack 2.

On the other hand, if the battery voltage detected is greater than the threshold voltage (Step S33: NO), it is determined that the battery pack 2 is not in an over-discharge state, and then in Step S40 the microcomputer 50 determines whether or not a signal is supplied from the protection IC 2b of the battery pack 2. If no signal is supplied from the protection IC 2b (Step S40: NO), in Step S41 the microcomputer 50 starts the battery charge with the normal charging current J1. In S42 the microcomputer 50 continues charging the battery pack 2, and determines whether the battery pack 2 is fully charged. When the battery pack 2 is fully charged (Step S42: YES), then in Step S43 the microcomputer 50 stops the battery charge. After that, when the battery pack 2 is removed from the charging device 1 (Step S44: YES), the microcomputer 50 waits for the next battery pack 2 to be mounted. Here, as in the case of the third embodiment, when the battery pack 2 is removed before the charging is ended, the charging device 1 resets the conditions, and enters a standby mode to wait for the next battery pack 2 to be mounted.

If the signal supplied from the protection IC 2b (Step S40: YES), the battery already has been fully charged, or the protection IC 2b stops the battery charge for some reason. Accordingly, the microcomputer 50 does not perform the charging of the battery pack 2, and in Step S43 ends the battery charge.

The microcomputer 50 appropriately changes the threshold voltage for determining whether the battery pack 2 is in an over-discharge state depending on the rated voltage of the battery pack 2, and therefore can properly determine the over-discharge state of the battery pack 2. When it is determined that the battery pack 2 is in an over-discharge state, the pre-charging is performed over a predetermined period of time. Based on how the voltage of the battery pack 2 has risen, the microcomputer 50 determines whether or not the charging should continue by checking whether or not the battery pack 2 is normal.

### Fourth Embodiment

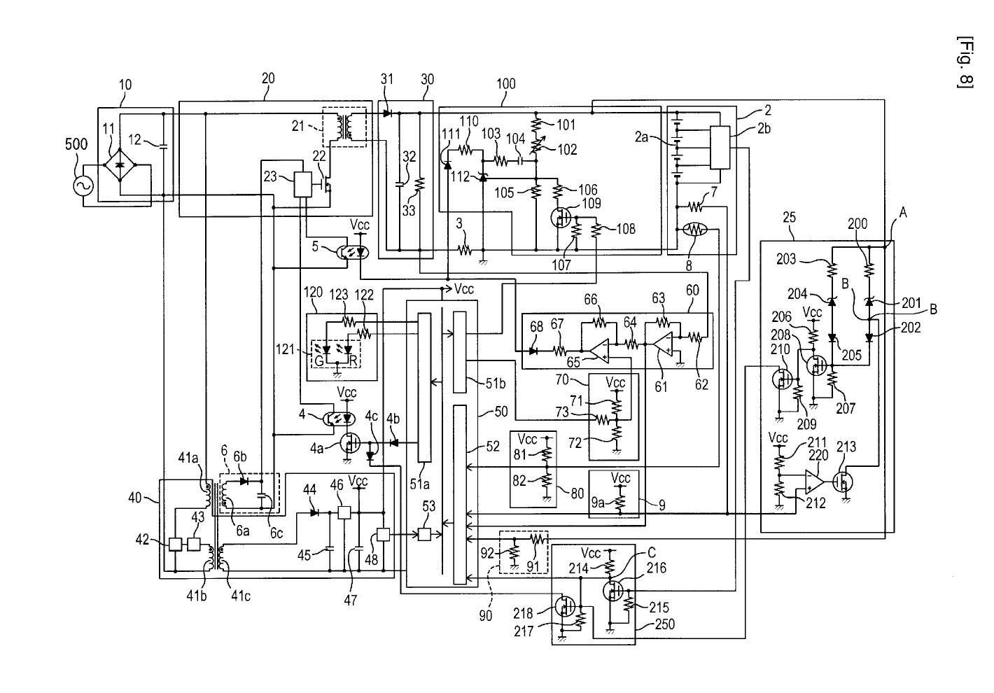

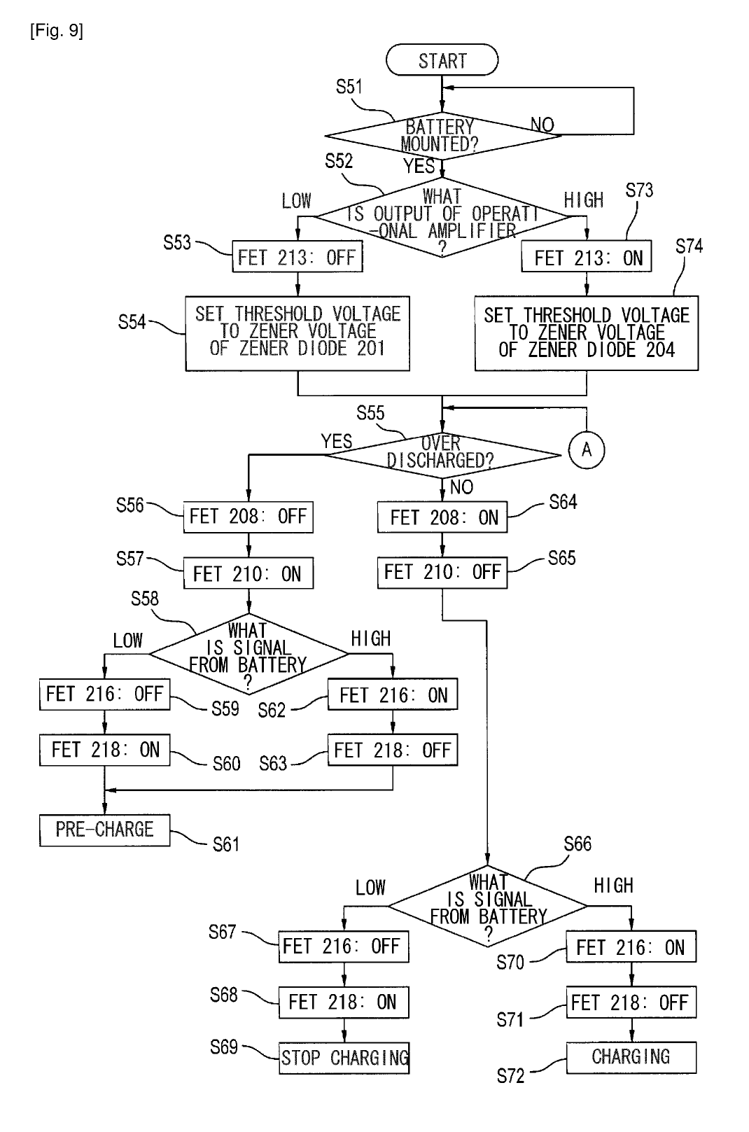

A fourth embodiment of the present invention will be described with reference to FIGS. 8 and 9. According to the fourth embodiment, a threshold voltage is set in the threshold voltage setting circuit 25 for determining an over-discharge state such that the threshold voltage can be changed between a battery pack with a large number of cells connected in series and a battery pack with a small number of cells connected in series. Moreover, the charging device 1 tries to pre-charge and charge the battery pack 2 in which the battery voltage of one of the battery cell is less than or equal to a discharge limit voltage and in which the protection IC 2b outputs a low signal indicating some alerts. The charging device 1 of the fourth embodiment is basically the same with the charging device 1 of the second embodiment shown in FIG. 3, however the charting device of the fourth embodiment further includes an error signal processing circuit 250. The following only describes portions that are different from those of the charging device 1 shown in FIG. 3.

In the fourth embodiment, the microcomputer 50 outputs a high signal to the charging control signal transmission section 4 when the microcomputer 50 receives the low signal from the node C via the A/D input port 52. On the other hand, the microcomputer 50 stops to output a high signal to the charging control signal transmission section 4 via the output port 51a when the microcomputer 50 receives the high signal from the node C via the A/D input port 52.

As shown in FIG. 8, the alert (or “some error”) signal processing circuit 250 includes resistors 214, 215, and 217, and FETs 216 and 218. The error signal processing circuit 250 is inserted between the threshold voltage setting circuit 25 and the first output port 51a of a microcomputer 50. Based on a signal from a protection IC 2b and the threshold voltage setting circuit 25, the error signal processing circuit 250 inputs a signal for stopping the battery charge into an A/D input port 52 of the microcomputer 50, and blocks a signal output from the microcomputer 50 to a charging signal transmission section 4.

In the error signal processing circuit 250, from a power supply voltage Vcc to a reference potential, the resistor 214 and the FET 216 are sequentially connected in series and in this order. A drain of the FET 216 is connected to the resistor 214, and to the A/D input port 52 of the microcomputer 50. A source of the FET 216 is connected to the reference potential, and a gate of the FET 216 is connected to the protection IC 2b of the battery pack 2. The resistor 215 is connected between the gate and source of the FET 216. A drain of the FET 218 is connected to an output line of the first output port 51a of the microcomputer 50 via a diode 4c, a source of the FET 218 is connected to the reference potential, and a gate of the FET 218 is connected to a node C, which is a connection point of the resistor 214 and the drain of the FET 216. The resistor 217 is connected between the source and gate of the FET 218.

The operation of the charging device 1 shown in FIG. 8 will be described with reference to FIG. 9.

First, the case where a low-rated-voltage battery pack in which the small number of battery cells 2a is connected in series, is connected to the charging device 1 will be described. After the battery pack 2 is mounted on the charging device 1 (Step S51: YES), the battery type identification resistor 7 of the battery pack 2 is connected in series to the reference resistor 9a of the charging device 1. In the threshold voltage setting circuit 25, a divided voltage obtained by dividing the power supply voltage Vcc with the battery type identification resistor 7 and the reference resistor 9a is input to the non-inverting input terminal of the operational amplifier 220. At this time, if the number “a” of battery cells 2a connected in series is five, the value of the divided voltage is smaller than the reference, and the operational amplifier 220 therefore outputs a low signal (Step S52: Low). In response to the low signal output from the operational amplifier 220, in Step S53 the FET 213 is turned OFF. At this time, a voltage corresponding to the battery voltage is applied to the zener diodes 201 and 204. Therefore, the FET 208 is turned ON/OFF depending on the magnitude relation between the zener voltage V1 of the zener diode 201 and the battery voltage. That is, in Step S54 the threshold voltage setting circuit 25 sets the threshold voltage to the zener voltage of the zener diode 201. In other words, the zener voltage V1 is set as the threshold voltage that is used to determine whether the battery pack 2 is in the over-discharge state.

When the battery voltage is less than the breakdown voltage V1 (Step S55: YES), in Step S56 the FET 208 is turned OFF, and in Step S57 the FET 210 is turned ON. At this time, a signal warning of over-discharge (low signal) is also output from the protection IC 2b (Step S58: Low), and in Step S59 the FET 216 is turned OFF. Because the FET 216 is turned OFF, the node C is not connected to the reference potential via the FET 216. However, as described above, because the FET 210 of the threshold voltage setting circuit 25 is turned ON, that is, the node C is connected to the reference potential via FET 210, no signal is applied to the gate of the FET 218. Thus, the FET 218 remains the OFF state. Accordingly, in Step S60 a low signal is inputted to the A/D input port 52 of the microcomputer 50. Though the low signal is inputted to the A/D input port 52 from the node C, in Step S61 the microcomputer 50 outputs the high signal toward the charging control signal transmission section 4 via the output port 51a based on the battery voltage of the battery pack 2 detected by the battery voltage detection circuit 90 in order to pre-charges the battery pack 2. The precharging of the battery pack 2 is performed similarly to the third embodiment. The high signal outputted from the output port 51a is not lowered to the reference potential by the FET 218, and is transmitted to the charging control signal transmission section 4. Accordingly, the microcomputer 50 can pre-charge the battery pack 2 based on the battery voltage of the battery pack 2 detected by the battery voltage detection circuit 90.

When the low signal is not output from the protection IC 2b of the battery pack 2, that is, the high signal is output form the protection IC 2b (Step S58: High), in Step S62 the FET 216 is turned ON. Because the FET 216 is turned ON, the node C is connected to the reference potential through the FET 216, and in Step S63 the FET 218 is turned OFF. The low signal is inputted to the A/D input port 52 from the node C. In Step S61 the microcomputer 50 outputs the high signal toward the charging control signal transmission section 4 via the output port 51a based on the battery voltage of the battery pack 2 detected by the battery voltage detection circuit 90 in order to precharges the battery pack 2. The high signal output from the output port 51a is not lowered to the reference potential by the FET 218, and transmitted to the charging control signal transmission section 4. Thus, the microcomputer 50 can pre-charge the battery pack 2 based on the battery voltage of the battery pack 2 detected by the battery voltage detection circuit 90.

When the battery voltage is greater than or equal to the zener voltage V1 (Step S55: NO), the battery pack 2 is not in an over-discharge state, and thus in Step S64 the FET 208 is turned ON, and in Step S65 the FET 210 is turned OFF. That is, the threshold voltage setting circuit 25 is electrically disconnected from other components of the charging device 1. At this time, when a signal (low signal) is output from the protection IC 2b (Step S66: Low), in Step S67 the FET 216 is turned OFF. As the FET 216 is turned OFF, in Step S68 a high signal is input to the A/D port 52 of the microcomputer 50 to stop the charging, and the FET 218 is turned ON at the same time. Accordingly, based on the signal for stopping the charging (high signal inputted from the A/D port 52), in S69 the microcomputer 50 stops an output from the output port 51a. Even if the output port 51a of the microcomputer 50 keeps outputting the high signal, the high signal is lowered to the reference potential by the FET 218. Accordingly, the charging of the battery pack 2 is forcibly stopped.

When the low signal is not output from the protection IC 2b (Step S66: high), that is, the high signal is output from the protection IC 2b (Step S66: High), the normal charging is available. Then, in Step S70 the FET 216 is turned ON, and in Step S71 a low signal is inputted to the A/D port 52 of the microcomputer 50, and the FET 218 is turned OFF at the same time. Accordingly, the charging device 1 continues the charging of the battery pack 2.

In Step 52, if the number a of battery cells 2a connected in series that constitute the battery pack 2 is 10, that is, the battery pack 2 is the high-rated-voltage, the operational amplifier 220 outputs a high signal because the value of the divided voltage is greater than the reference voltage (Step S52: High). In response to the high signal output from the operational amplifier 220, in Step S73 the FET 213 is turned ON. As the FET 213 is turned ON, the zener diode 204 becomes dominant for the process of turning the FET 208 ON/OFF. Therefore, in Step S72 the process is dependent on the zener voltage V4 of the zener diode 204. That is, the zener voltage V4 of the zener diode 204 is used as a threshold voltage for determining whether or not the battery pack 2 is in an over-discharge state. In the subsequent processes following Step S74, determinations with respect to pre-charging, stop of charging, or continuation of charging are made similarly to the above low-rated-voltage battery pack 2 (Steps S55 to S72).

Accordingly, when the number of battery cells 2a of the battery pack 2 that are connected in series is small, the zener voltage of the zener diode 201 can be used as a threshold voltage for determining whether or not the battery pack 2 is in an over-discharge state. When the number of battery cells 2a of the battery pack 2 that are connected in series is large, the zener voltage of the zener diode 204, which is higher than that of the zener diode 201, can be used as a threshold voltage for determining whether or not the battery pack 2 is in an over-discharge state. That is, depending on the number of cells of the battery pack 2 that are connected in series, a threshold voltage for determining whether or not the battery pack 2 is in an over-discharge state can be selectively set.

In a normal charging device, if the battery pack 2 is less than or equal to the discharge limit voltage, and a signal warning of over-discharge is generated from the protection IC 2b of the battery cells 2a, the charging is stopped. However, according to the present embodiment, even in such cases, the microcomputer 50 pre-charges the battery pack 2, and can continue the charging of the battery pack 2.

Without using the microcomputer 50, the threshold voltage setting circuit 25 and the error signal processing circuit 250 determines whether the battery pack 2 is in an over-discharge state. Therefore, even if a failure occurs in the microcomputer 50, the threshold voltage for determining whether the battery pack 2 is in the over-discharge state is set based on the number of battery cells of the battery pack 2 that are connected in series.

### Fifth Embodiment

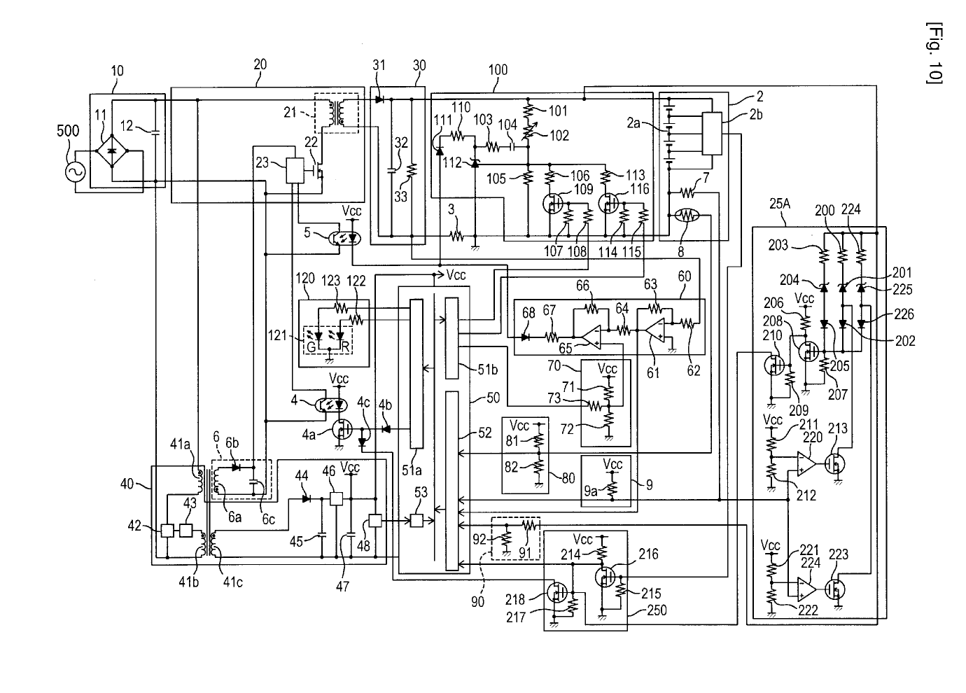

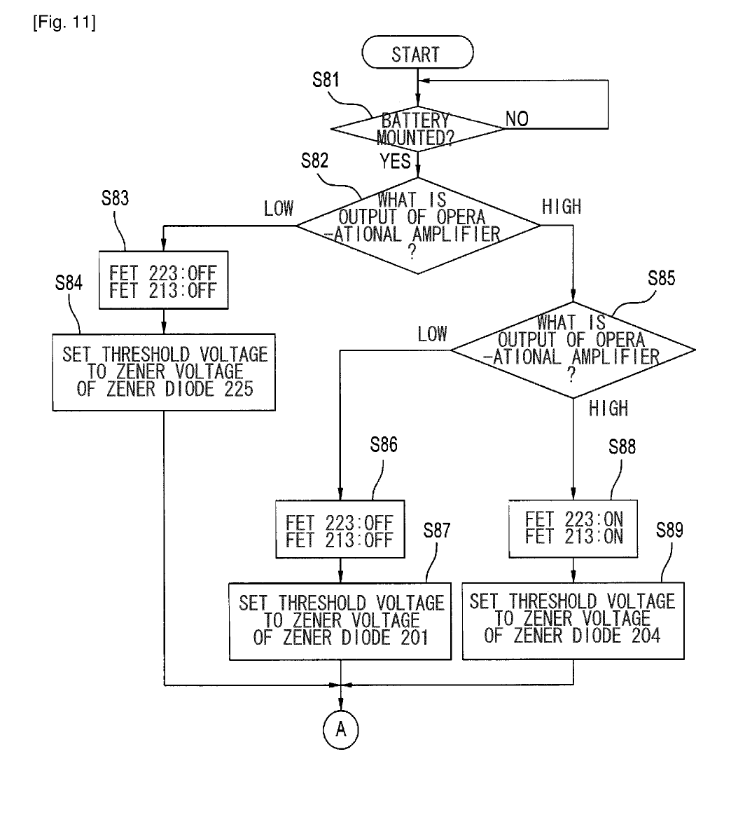

A charging device 1 of a fifth embodiment of the present invention will be described with reference to FIGS. 10 and 11. The configuration of the charging device 1 shown in FIG. 10 is basically the same as that of the charging device 1 shown in FIG. 8. In the threshold voltage setting circuit 25 shown in FIG. 8, one operational amplifier 220 is used, and resistance values of the battery type identification resistor 7 of the battery pack 2 are classified into two, large and small. That is, in the fourth embodiment, two threshold voltages for determining whether the battery pack 2 is in an over-discharge state can be selected depending on the number of zener diodes. However, in the present embodiment, the charging device 1 includes a threshold voltage setting circuit 25A shown in FIG. 10 instead of the threshold voltage setting circuit 25. The threshold voltage setting circuit 25A includes two operational amplifiers 220 and 224, and classifies resistance values of a battery type identification resistor 7 of a battery pack 2 into three types. In order to set three threshold voltages for determining an over-discharge state, the threshold voltage setting circuit 25A further includes three zener diodes 201, 204, and 225. A threshold voltage can be selected from the three threshold voltages.

The threshold voltage setting circuit 25A further includes resistors 200, 203, 206, 207, 209, 211, 212, 221, and 222, FETs 208, 210, 213, and 223, and diodes 202, 205, and 226. The zener voltages of the zener diodes 204 is largest among the zener diodes 201, 204, and 225. The zener voltage of the zener diode 225 is the smallest. A reference voltage inputted to an inverting input terminal of the operational amplifier 220 is larger than a reference voltage inputted to an inverting input terminal of the operational amplifier 224.

The operation of the charging device 1 shown in FIG. 10 will be described with reference to FIG. 11.

First, the case where a low-rated-voltage battery pack in which the number of battery cells 2a connected in series is five for example, is connected to the charging device 1 will be described. After the battery pack 2 is mounted on the charging device 1 (Step S81: YES), the battery type identification resistor 7 of the battery pack 2 is connected in series to the reference resistor 9a of the charging device 1. In the threshold voltage setting circuit 25A, a divided voltage obtained by dividing the power supply voltage Vcc with the battery type identification resistor 7 and the reference resistor 9a is input to the non-inverting input terminal of the operational amplifiers 220 and 224. At this time, if the number “a” of battery cells 2a connected in series is five, the value of the divided voltage is smaller than references of the operational amplifiers 220 and 224, and the operational amplifiers 220 and 224 therefore output low signals (Step S82: Low). In response to the low signals output from the operational amplifier 220 and 224, in Step S83 the FET 213 and 223 are turned OFF. At this time, a voltage corresponding to the battery voltage is applied to the zener diodes 201, 204, and 225. Therefore, the FET 208 is turned ON/OFF depending on the magnitude relation between the battery voltage and the zener voltage of the zener diode 225, which has the smallest zener-diode breakdown voltage. That is, in Step S84 the threshold voltage setting circuit 25A sets the threshold voltage by the zener voltage of the zener diode 225. In other words, the zener voltage of the zener diode 225 is used as the threshold voltage for determining whether or not the battery pack 2 is in an over-discharge state.

In a case where a medium-degree rated-voltage battery pack 2 in which the number a of battery cells 2a are connected in series is seven is connected to the charging device 1, a high signal is output from the operational amplifier 224 due to the divided voltage based on the identification resistor 7 (Step S82: High), while a low signal is output from the other operational amplifier 220 (Step S85: Low). In this case, in Step 86 the FET 223 is turned ON, but the FET 213 remains OFF. At this time, the FET 208 is turned ON/OFF depending on the magnitude relation of the battery voltage and the zener voltage of the zener diode 201, which has a medium-level breakdown voltage. That is, in Step S87 the threshold voltage setting circuit 25A sets the threshold voltage by the zener voltage of the zener diode 201. The zener voltage of the zener diode 201 is used as the threshold voltage for determining whether or not the mounted battery pack 2 is in an over-discharge state.

In a case where the high-rated-voltage battery pack 2 in which the number a of battery cells 2a are connected in series is 10 is connected to the charging device 1, the operational amplifier 224 outputs a high signal based on the divided voltage based on the identification resistor 7 (Step S82: High), and the operational amplifier 220 also outputs a high signal (Step S85: High). Therefore, in Step S88 both the FETs 223 and 213 are turned ON. At this time, the FET 208 is turned ON/OFF depending on the magnitude relation between the battery voltage and the zener voltage of the zener diode 204, which has the highest breakdown voltage. That is, in Step S89 the threshold voltage setting circuit 25A sets the threshold voltage by the zener voltage of the zener diode 204. In the words, the zener voltage of the zener diode 204 is used as a threshold voltage for determining whether or not the mounted battery pack 2 is in an over-discharge state.

Accordingly, in accordance with the number of battery cells 2a of the battery pack 2 that are connected in series, and using the three zener diodes 201, 204, and 225, an appropriate threshold voltage is selected from the three threshold voltages. Then, the process proceeds to step S55 shown in FIG. 9, and, in accordance with an over-discharge state of the battery pack 2 and a signal from the protection IC 2b, pre-charging, stop of charging, or normal charging is carried out.

Therefore, in accordance with the number of battery cells of the battery pack that are connected in series, a threshold voltage of discharge limit voltage can be selected.

The above described embodiments only illustrate one form of the present invention. The battery pack 2 may include any number of battery cells 2a connected in series.

In the above embodiments, the number of zener diodes in the threshold voltage setting circuit is two or three. However, the present invention is not limited thereto. A plurality of zener diodes may be provided. The threshold voltage setting circuit sets the threshold voltage for determining the over-discharge from the plurality of threshold voltages that depends on the plurality of zener diodes. Further, in the above described embodiments in which the pre-charge is performed, the charging device 1 always performs the pre-charge irrespective of the value of the set (selected) threshold voltage. However, the charging device 1 may performs the pre-charge only when the set (selected) threshold voltage satisfies a prescribed condition. For example, the charging device 1 performs the pre-charge only when the set (selected) threshold voltage is a specific value, or one of specific values. Or, the charging device 1 performs the precharge only when the set (selected) threshold voltage is not a specific value.

### REFERENCE SIGN LIST

1 charging device
2 battery pack
7 identification resistor
50 microcomputer
90 battery voltage detection circuit
9 battery type determination circuit
700 component temperature detection section

1. A charging device comprising:
a terminal configured to connect a rechargeable battery;
a first power feeding unit configured to charge the rechargeable battery connected to the terminal;
a controller configured to control the first power feeding unit;
a monitoring unit; and
a second power feeding unit configured to feed electrical power to the controller and the monitoring unit,
wherein the monitoring unit includes;
a monitoring portion configured to monitor at least one of the rechargeable battery, the first power feeding unit, and the controller; and
a switching element configured to interrupt the second power feeding unit to feed the electrical power to the monitoring portion.

2. The charging device according to claim 1, wherein the monitoring portion includes: a first monitoring portion configured to monitor one of the rechargeable battery, the first power feeding unit, and the controller; and a second monitoring portion configured to monitor remaining one of the rechargeable battery, the first power feeding unit, and the controller,
wherein the switching unit is configured to interrupt the second power feeding unit to feed the electrical power to at least one of the first monitoring portion and the second monitoring portion.

3. The charging device according to claim 1, wherein the monitoring portion includes an identifying unit to be used by the controller to identify the rechargeable battery based on an identifier included in the rechargeable battery,
wherein the switching element interrupts the second power feeding unit to feed the electrical power to the identifying unit after the controller identifies the rechargeable battery.

4. The charging device according to claim 3, wherein the switching unit interrupts the second power feeding unit to feed the electrical power to the monitoring portion when or after the first feeding unit finishes to charge the rechargeable battery.

5. The charging device according to claim 3, wherein the identifier includes a first resistor,
wherein the identifying unit includes a second resistor,
wherein the controller is configured to identify a type of the rechargeable battery by comparing the first resistor with the second resistor.

6. The charging device according to claim 1, wherein the monitoring portion includes a temperature monitoring portion configured to monitor at least one of a temperature of the first feeding unit and a temperature of the rechargeable battery,
wherein the controller outputs a controlling signal to the first feeding unit, the controlling signal controlling the first feeding unit to charge the rechargeable battery,
wherein the switching element allows the second feeding unit to feed the electrical power to the temperature monitoring portion while the controller outputs the controlling signal.

7. The charging device according to claim 6, wherein the temperature monitoring portion includes a thermistor.

8. The charging device according to claim 1, the monitoring portion includes a voltage monitoring portion configured to monitor at least one of a battery voltage of the rechargeable battery, and an output voltage of the first power feeding unit,
wherein the controller outputs a controlling signal to the first feeding unit, the controlling signal controlling the first feeding unit to charge the rechargeable battery,
wherein the switching element allows the second feeding unit to feed the electrical power to the voltage monitoring portion while the controller outputs the controlling signal.

9. The charging device according to claim 1, wherein the controller outputs a controlling signal to the first feeding unit, the controlling signal controlling the first feeding unit to charge the rechargeable battery,
wherein the switching element interrupts the second feeding unit to feed the electrical power to the monitoring portion based on the controlling signal.

10. A charging device comprising:
a terminal configured to connect a batter pack;
an identifying unit configured to identify a rated voltage of the battery pack connected to the terminal from among a plurality of rated voltages;
a charging unit configured to charge the battery pack connected to the terminal;
a threshold selecting unit configured to select a threshold value of the battery pack connected to the terminal from among a plurality of threshold values based on the identified rated voltage; and
a determining unit configured to determine whether a battery voltage of the battery pack is less than the selected threshold value.

11. The charging device according to claim 10, wherein the threshold selecting unit selects the threshold value of the battery pack as a lower limit of the battery voltage of the battery pack based on the identified rated voltage.

12. The charging device according to claim 10, wherein the plurality of threshold values includes two threshold values.

13. The charging device according to claim 10, wherein the plurality of threshold values includes three threshold values.

14. The charging device according to claim 10, wherein the threshold selecting unit includes a plurality of Zener diodes being in one-to-one correspondence with the plurality of threshold values.

15. The charging device according to claim 10, wherein the threshold selecting unit includes a logical operation circuit configured to compare the selected threshold value with the battery voltage of the batter pack.

16. The charging device according to claim 10, wherein the charging unit stops charging the battery pack connected to the terminal when the determining unit determines that the battery voltage of the battery pack is less than the selected threshold value.

17. The charging device according to claim 10, wherein if the determining unit determines that the battery voltage of the battery pack is less than the selected threshold value, the charging unit performs pre-charge operation in which the battery pack is charged such that a load of the battery pack is reduced than when normally charging the battery pack.

18. The charging device according to claim 10, wherein the determining unit detects a signal transmitted from the battery pack when the battery pack is over-charged or over-discharged.

19. The charging device according to claim 10, wherein the battery pack includes a lithium-ion battery cell.
